(19) United States
(12) Patent Application Publication
(10) Pub. No.: US 2019/0328127 A1
(43) Pub. Date: Oct. 31, 2019

(54) Support for Mobile Phone or Tablet Computer

(71) Applicant: Pengfei Jia, Zhejiang Province (CN)

(72) Inventor: Pengfei Jia, Zhejiang Province (CN)

(21) Appl. No.: 16/112,569

(22) Filed: Aug. 24, 2018

(30) Foreign Application Priority Data
Apr. 28, 2018 (CN) 2018104028358

(51) Int. Cl. A47B 19/00; F16M 11/04; F16B 2/12; H04B 1/3827

(52) U.S. Cl. CPC A47B 19/00; H04B 1/3827; F16B 2/12; F16M 11/041

(57) ABSTRACT

The invention discloses a support for a mobile phone or a tablet computer, comprising a beam, covers, a fixed block, sliding blocks, supporting legs and supporting leg retaining bases, the surface of the beam is provided with a chute along the length of the beam, the fixed block is fixed in the middle of the chute, the surface of the fixed block is provided with a receding groove for an object to be clamped, the sliding blocks are mounted at the two sides of the fixed block, the sliding blocks are in sliding fit with the chute, and a clamping rod is hinged to each sliding block.

### CROSS REFERENCE TO RELATED APPLICATION

This application claims priority from Chinese Patent Application No. 201810402835.8, filed Apr. 28, 2018 and entitled “Support for Mobile Phone or Tablet Computer” the disclosure of which is hereby incorporated entirely herein by reference.

### FIELD OF THE INVENTION

The invention relates to a support, in particular to a support for a mobile phone or a tablet computer.

### BACKGROUND OF THE INVENTION

With the increasing popularity of smartphones, people use their mobile phones more frequently, but when people hold their mobile phones or tablet computers to watch movies for a long time, both inconvenience and hand fatigue are caused, and the using experience is affected. Therefore, a support for a mobile phone or a tablet computer is produced accordingly. An existing support is inconvenient to operate and carry, affecting normal use and reducing the using experience.

### SUMMARY OF THE INVENTION

The invention aims to provide a support for a mobile phone or a tablet computer, to solve the above-mentioned problems in the background art.

To achieve the above objective, the invention provides the following technical solutions:

The support for the mobile phone or the tablet computer comprises a beam, covers, a fixed block, sliding blocks, supporting legs and supporting leg retaining bases, wherein the surface of the beam is provided with a chute along the length of the beam, the fixed block is fixed in the middle of the chute, the surface of the fixed block is provided with a receding groove for an object to be clamped, the sliding blocks are mounted at the two sides of the fixed block, the sliding blocks are in sliding fit with the chute, and a clamping rod is hinged to each sliding block; the supporting leg retaining bases are hinged to both ends of the beam, a pair of supporting legs are hinged to each supporting leg retaining base, a length of each supporting leg is adjustable, the covers are further mounted on the supporting leg retaining bases, and the covers are in inserting fit with both ends of the beam to package the supporting leg retaining bases inside.

As a further solution of the invention, the opposite sides of the two clamping rods are provided with arc-shaped clamping grooves respectively, and a cushion is fixed in each clamping groove.

As a yet further solution of the invention, the two sliding blocks are connected with the fixed block via springs respectively.

As a yet further solution of the invention, each supporting leg comprises a primary rod body, a secondary rod body and a sliding switch, one end of the primary rod body is in hinging fit with the corresponding supporting leg retaining base, the other end of the primary rod body is inserted into the secondary rod body and in sliding fit with the secondary rod body, and the sliding switch is used for adjusting an insertion depth of the primary rod body.

As a yet further solution of the invention, a non-slip mat is fixed to the bottom end of each secondary rod body.

Compared with the prior art, the support for the mobile phone or the tablet computer has the beneficial effects that the mobile phone or the tablet computer can be conveniently clamped, and the height and the angle can be conveniently adjusted so as to obtain a more superior experience when the mobile phone or the tablet computer is used; meanwhile, the supporting legs of each pair have matched sloped faces, when put away, the supporting legs of each pair can be placed under the beam closely attached to each other, and then the covers and both ends of the beam are fixed through insertion, forming a regular geometric shape, which is easy to carry.

### BRIEF DESCRIPTION OF THE FIGURES

FIG. 1 is a schematic structural view of a support for a mobile phone or a tablet computer.

FIG. 2 is a front view of a support for a mobile phone or a tablet computer.

FIG. 3 is a top view of a support for a mobile phone or a tablet computer.

FIG. 4 is a schematic structural view of a support for a mobile phone or a tablet computer when put away.

In the drawings: 1—beam, 2—cover, 3—chute, 4—fixed block, 5—sliding block, 6—clamping rod, 7—clamping groove, 8—supporting leg, 801—primary rod body, 802—secondary rod body, 803—sliding switch, 9—supporting leg retaining base.

### DETAILED DESCRIPTION OF THE INVENTION

The following clearly and completely describes the technical solutions in the embodiment of the invention with reference to the accompanying drawings in the embodiment of the invention. Apparently, the described embodiment is merely part of but not all of the embodiments of the invention. All other embodiments obtained by a person of ordinary skill in the art based on the embodiment of the invention without creative efforts shall fall within the protection scope of the invention.

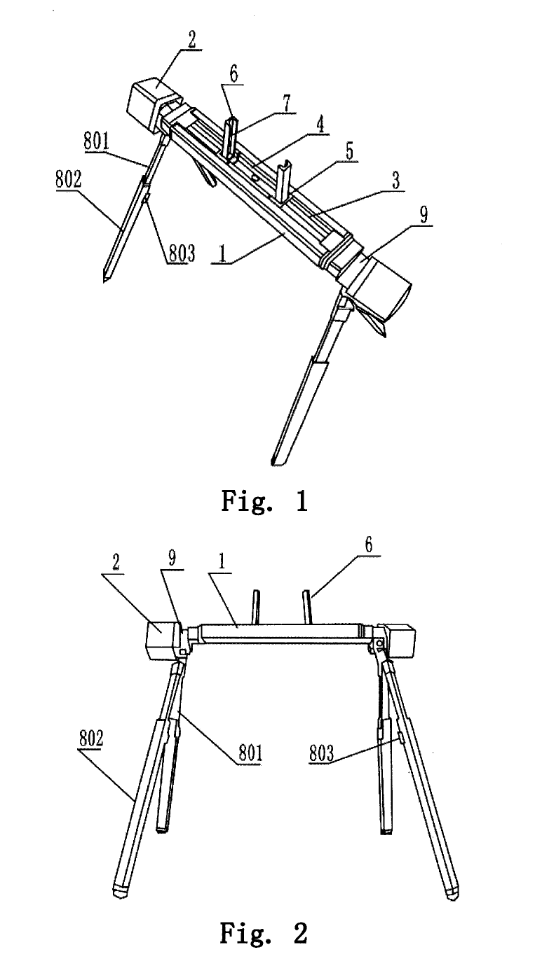

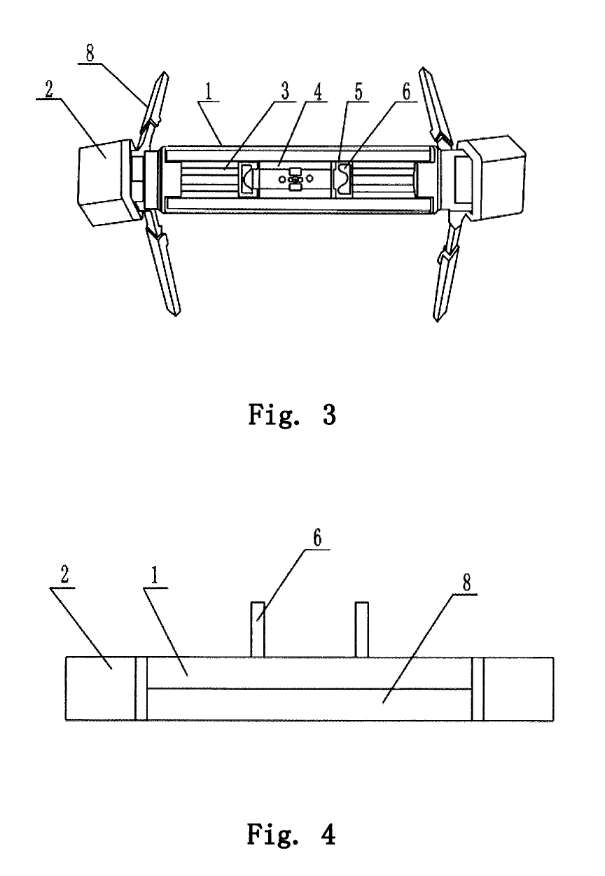

Please refer to FIG. 1 to FIG. 4, in the embodiment of the invention, a support for a mobile phone or a tablet computer comprises a beam 1, covers 2, a fixed block 4, sliding blocks 5, supporting legs 8 and supporting leg retaining bases 9, the surface of the beam 1 is provided with a chute 3 along the length of the beam, the fixed block 4 is fixed in the middle of the chute 3, the surface of the fixed block 4 is provided with a receding groove for an object to be clamped, the sliding blocks 5 are mounted at the two sides of the fixed block 4, the sliding blocks 5 are in sliding fit with the chute 3, and a clamping rod 6 is hinged to each sliding block 5. In work, the clamping rods 6 are rotated to be perpendicular to the plane where the sliding blocks 5 are located, the mobile phone or the tablet computer is placed in the receding groove formed in the fixed block 4, and by adjusting the position of each sliding block 5, the mobile phone or the tablet computer can be clamped and fixed by the clamping rods 6. the supporting leg retaining bases 9 are hinged to both ends of the beam 1, a pair of supporting legs 8 are hinged to each supporting leg retaining base 9, and a length of each supporting leg 8 is adjustable. After the mobile phone or the tablet computer is well fixed, the beam 1 can be supported by unfolding the supporting legs 8. The covers 2 are further mounted on the supporting leg retaining bases 9, and the covers 2 are in inserting fit with both ends of the beam 1 to package the supporting leg retaining bases 9 inside. When not used, the support can be put away conveniently. In addition, in the embodiment, the supporting legs 8 of each pair have matched sloped faces, when put away, the supporting legs 8 of each pair can be placed under the beam 1 closely attached to each other, and then the covers 2 and both ends of the beam 1 are fixed through insertion, forming a regular geometric shape, which is easy to carry.

The opposite sides of the two clamping rods 6 are provided with arc-shaped clamping grooves 7 respectively to be better matched with the object to be clamped. In order to prevent the damage to the object to be clamped by the clamping rods 6, a cushion is fixed in each clamping groove 7.

The two sliding blocks 5 are connected with the fixed block 4 via springs (not shown) respectively, in this way, the sliding blocks 5 can come near to the fixed block 4 under the action of the springs, facilitating automatic clamping.

Each supporting leg 8 comprises a primary rod body 801, a secondary rod body 802 and a sliding switch 803, one end of the primary rod body 801 is in hinging fit with the corresponding supporting leg retaining base 9, the other end of the primary rod body 801 is inserted into the secondary rod body 802 and in sliding fit with the secondary rod body 802, and the sliding switch 803 is used for adjusting an insertion depth of the primary rod body 801 and allows the length of the supporting leg 8 to be adjusted conveniently, so as to obtain a more superior experience when the mobile phone or the tablet computer is used.

A non-slip mat is fixed to the bottom end of each secondary rod body 802 so as to guarantee the stability of the support in use.

The working principle of the support is as follows: when in use, the covers 2 on both sides of the beam 1 are pulled open, the supporting legs 8 are rotated so as to be in contact with the ground, the length of the supporting legs 8 can also be adjusted, then the clamping rods 6 are rotated to be perpendicular to the plane where the sliding blocks 5 are located, the mobile phone or the tablet computer is placed in the receding groove formed in the fixed block 4, and by adjusting the position of each sliding block 5, the mobile phone or the tablet computer can be clamped and fixed by the clamping rods 6; when not used, the support can be put away conveniently.

For a person skilled in the art, it is apparent that the invention is not limited to the details of the above exemplary embodiment, and the invention can be implemented in other specific forms without departing from the spirit or essential characteristics of the invention. Therefore, in any respect, the embodiment should be regarded as exemplary and not restrictive, and the scope of the invention is defined by the appended claims rather than the above description. It is therefore intended that all changes that come within the meaning and range of equivalency of the claims are embraced by the invention. Any reference signs in the claims should not be regarded as limiting the involved claims.

In addition, it should be understood that although the specification is described in terms of embodiments, not every embodiment includes only a single technical solution. This description of the specification is merely for the sake of clarity, and those skilled in the art should consider the specification as a whole. The technical solutions in the embodiments can also be combined as appropriate to form other embodiments that can be understood by those skilled in the art.

1. A support for a mobile phone or a tablet computer, comprising a beam (1), covers (2), a fixed block (4), sliding blocks (5), supporting legs (8) and supporting leg retaining bases (9), characterized in that the surface of the beam (1) is provided with a chute (3) along the length of the beam, the fixed block (4) is fixed in the middle of the chute (3), the surface of the fixed block (4) is provided with a receding groove for an object to be clamped, the sliding blocks (5) are mounted at the two sides of the fixed block (4), the sliding blocks (5) are in sliding fit with the chute (3), and a clamping rod (6) is hinged to each sliding block (5); the supporting leg retaining bases (9) are hinged to both ends of the beam (1), a pair of supporting legs (8) are hinged to each supporting leg retaining base (9), a length of each supporting leg (8) is adjustable, the covers (2) are further mounted on the supporting leg retaining bases (9), and the covers (2) are in inserting fit with both ends of the beam (1) to package the supporting leg retaining bases (9) inside.

2. The support for the mobile phone or the tablet computer according to claim 1, characterized in that the opposite sides of the two clamping rods (6) are provided with arc-shaped clamping grooves (7) respectively, and a cushion is fixed in each clamping groove (7).

3. The support for the mobile phone or the tablet computer according to claim 2, characterized in that the two sliding blocks (5) are connected with the fixed block (4) via springs respectively.

4. The support for the mobile phone or the tablet computer according to claim 3, characterized in that each supporting leg (8) comprises a primary rod body (801), a secondary rod body (802) and a sliding switch (803), one end of the primary rod body (801) is in hinging fit with the corresponding supporting leg retaining base (9), the other end of the primary rod body (801) is inserted into the secondary rod body (802) and in sliding fit with the secondary rod body (802), and the sliding switch (803) is used for adjusting an insertion depth of the primary rod body (801).

5. The support for the mobile phone or the tablet computer according to claim 4, characterized in that a non-slip mat is fixed to the bottom end of each secondary rod body (802).
